(19) United States
(12) Patent Application Publication
(10) Pub. No.: US 2026/0093719 A1
(43) Pub. Date: Apr. 2, 2026

(54) METHOD FOR GENERATING A LIST OF TEXT RECORDS USING A DATABASE OF TEXT RECORDS OF A HIERARCHICAL CLASSIFIER WITH SEVERAL LEVELS OF NESTING

(71) Applicant: Anna Valerevna Chernyaeva, Moscow (RU)

(72) Inventor: Maxim Andreevich Chernyaev, Moscow (RU)

(21) Appl. No.: 19/288,986

(22) Filed: Aug. 2, 2025

(30) Foreign Application Priority Data
Sep. 27, 2024 (RU) 2024128775

(51) Int. Cl. G06F 16/31; G06F 40/14

(52) U.S. Cl. CPC G06F 16/313; G06F 16/322; G06F 40/14

(57) ABSTRACT

In a preferred embodiment claimed a method for generating a list of text entries executed by the processor of a computer device, containing the following steps: forming request to a database of the text records of a hierarchical classifier with several levels of nesting, and the database contains at least a set of the associated text records, wherein each of the associated text records associated with at least one first sign of connectivity, and each first sign of connectivity corresponds to one of the subheadings, and each unique text record is associated with a unique title, wherein each unique title contains a list consisting of at least plurality of the unique subheadings; and the unique text records are associated in the database with one of the mentioned unique subheadings to obtain a set of associated text records; extracting multiple associated text records from the database; forming a list from the extracted text records, wherein the text records are written in the list using a delimiter.

### FIELD OF THE INVENTION

The present technical solution pertains to the field of digital technologies, specifically to methods for generating text record databases of a hierarchical classifier with multiple levels of nesting.

### BACKGROUND

In the traditional trademark application process, selecting the correct list of goods and services, accurately reflecting the required goods and/or services, and thus appropriately choosing classes in accordance with the International Classification of Goods and Services (ICGS), is relatively complex.

Generally, this process's complexity is due to the necessity of possessing specific professional knowledge related to trademark registration, making it practically impossible for individuals without such skills to properly prepare the documentation.

Additionally, in the current trademark application process, the selection of goods and services involves a search using exact or fuzzy words within the entire list of the Nice Classification to find similar results. However, users who are unfamiliar with the structure of the Nice Classification may find it challenging to locate the correct and relevant entries that identify goods and services. They may also overlook essential items needed for properly forming a trademark application (or service mark). For example, a clothing store owner may not know that they actually need “wholesale and retail sale of clothing.” Instead, they may attempt to find specific items in categories themselves, such as “women's clothing, men's clothing, shirts.”

On the other hand, in the context of business globalization, many companies and brands focused on international business place significant importance on the demand for trademarks and their protection. These companies and brands often register trademarks in multiple countries to protect their brand identity, ensuring uniqueness and recognizability worldwide. However, trademark laws and classification systems for trademarks may vary by country. Therefore, during the international registration of a trademark, issues often arise regarding the proper formation of goods and services concerning the requirements of a specific country's classifier.

In application TW 202349324 A (AIPLUX TECHNOLOGY CO LTD, 16.12.2023), a solution is proposed that involves creating a converter for the ICGS classifier that takes into account the enforcement regulations of the country where the trademark application is intended. This solution includes an electronic user-controlled device connected to a server, where specialized software implements an online trademark application module, allowing the user to enter the necessary information to file a trademark application. When the user selects the international trademark application option and specifies at least one additional country for the application, the processor activates a category conversion module in the application software.

The main disadvantage is its reliance on specific classifier formulations and the lack of automated selection of goods and services from the classifier for the required field when preparing a trademark registration application without the need to review the entire goods and services classifier.

### SUMMARY

The proposed technical solution addresses the issue of creating a more comprehensive and accurate classifier of goods and services, enabling the formation of hierarchical links for subsequent automated selection of required goods and services.

The technical result is the automation of the formation of the list of goods and services and the improvement of accuracy in forming the list of goods and services through the application of hierarchical interconnections using associated record features.

In a preferred embodiment claimed a method for generating a list of text entries executed by the processor of a computer device, containing the following steps:
forming request to a database of the text records of a hierarchical classifier with several levels of nesting, and the database contains at least a set of the associated text records, wherein each of the associated text records associated with at least one first sign of connectivity, and each first sign of connectivity corresponds to one of the subheadings, and each unique text record is associated with a unique title, wherein each unique title contains a list consisting of at least plurality of the unique subheadings;
and the unique text records are associated in the database with one of the mentioned unique subheadings to obtain a set of associated text records;
extracting multiple associated text records from the database;
forming a list from the extracted text records, wherein the text records are written in the list using a delimiter.

The method according to claim 1, wherein the set of extracted text records includes at least one of or any combination of:
the first associated text entry associated with the first unique subtitle,
the first unique subtitle,
the second unique subtitle,
the first associated text entry associated with the second unique subtitle.

The method according to claim 1, wherein the set of extracted text records includes at least one of or any combination of:
the first associated text entry associated with the first unique subtitle,
the first unique subtitle,
the second unique subtitle,
the first associated text entry associated with the second unique subtitle,
the second associated text record associated with the extracted first associated text record.

The method according to claim 1, wherein the delimiter is a semicolon followed by a space.

The method according to claim 1, wherein the generated list is written to an XML file with a structure.

Further specific embodiments of the claimed invention will be presented in the following application materials.

### BRIEF DESCRIPTION OF DRAWINGS

FIG. 1 illustrates a method for creating a database of unique entities.

FIG. 2 illustrates the database request process.

FIG. 3 illustrates a method for generating a list of goods and/or services using the database.

FIG. 4 illustrates an example of a computing device.

### DETAILED DESCRIPTION OF THE INVENTION

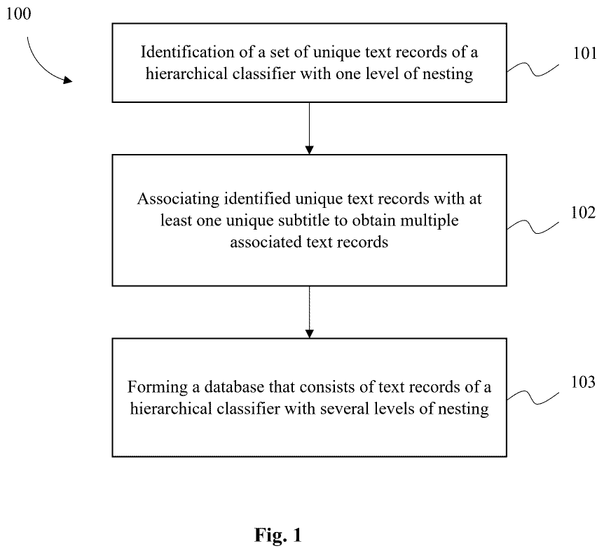

As shown in FIG. 1, the proposed solution includes a method (100) for creating a multi-level hierarchical database of text records. The method involves identifying (101) a set of unique text records in a single-level hierarchical classifier, which can be, for instance, an ICGS or any other classifier that has only one level of hierarchy, where entities are directly assigned to a class without intermediate levels. For example, each record in the ICGS, which is unique and identifies a specific product or service, is associated with a unique heading that provides a general description of the product or service class, such as ICGS Class 9, “Measuring and signaling equipment.”

Each unique heading contains a list comprising at least a set of unique subheadings, which represent specific product or service names, such as:
90151—Electrical observation and control equipment, except for medical purposes;
90149—Stamp payment control devices;
90067—Comparators;
90240—Material testing machines and instruments.

The description of each subheading is a unique text record that is associated (102) with one of the mentioned unique subheadings through a connectivity feature, which could be, for example, an identifier (ID) of the subheading, such as 90151, 90149, 90067, etc. This results in a set of associated text records. Using the associated data, a multi-level hierarchical database (103) is created, containing at least a set of the associated text records, with each record being linked to at least one first connectivity feature, where each first connectivity feature corresponds to one of the mentioned subheadings.

Some unique subheadings may be interlinked due to corresponding products or services that match different unique subheadings but share the same application field and are homogeneous. For example, the field “software” may include direct products in Class 9 ICGS, services for software development in Class 42, and software licensing services in Class 45 ICGS.

For association without specifying individual products and services, homogeneous products and services are linked by connecting their unique subheadings. This association is carried out by linking the unique identifier of the first unique subheading with the unique identifier of the second unique subheading, resulting in at least the first and second associated unique subheadings. In this case, the associated unique subheadings are not linked to the same unique heading.

If an associated text record is linked to the first associated unique subheading, then it is also linked to the second associated unique subheading, which is associated with the mentioned first associated unique subheading.

Through the association of unique text records, the created multi-level hierarchical classifier database contains at least a set of associated text records, each linked to multiple connectivity features. The number of such connectivity features corresponds to the number of associated unique subheadings, which are linked to each other. Additionally, the associated unique subheadings are not all linked to the same unique heading.

The set of associated text records may include sets of first and second associated text records, where at least one second associated text record is linked to at least one second connectivity feature, which may be a unique identifier of one of the first associated text records. Moreover, the second associated text record may be linked to the same associated unique subheading as the first associated text record linked to it.

The set of associated text records may include multiple first associated text records and multiple second associated text records. At least part of the set of unique text records may be obtained from at least one list of goods and services from a published trademark application or a registered trademark. The set of unique subheadings may include first unique subheadings and second unique subheadings.

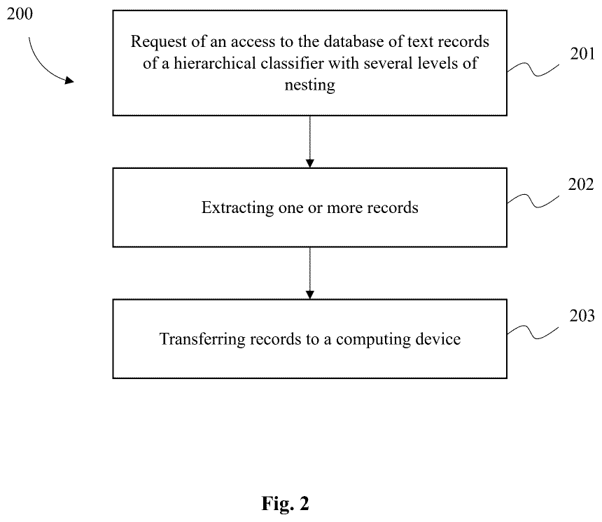

As shown in FIG. 2, the database created in the above manner is used for automated access (200) to unique associated text records when forming a list of goods and services by retrieving stored data. Initially, an access request (201) is made via a computing client or server device, followed by database access to retrieve (202) at least the first associated text record and at least the first unique subheading, the unique identifier of which serves as the first connectivity attribute of the retrieved first associated text record. The retrieved record is transferred (203) to the device that submitted the database access request to execute the retrieval process. The retrieved record may be displayed in a graphical interface implemented on the computing device or directly transferred for further creation of a list of goods and/or services.

Additionally, a second unique subheading associated with the retrieved first unique subheading may be retrieved. Furthermore, at least one other first associated text record associated with the retrieved second unique subheading may also be retrieved. Additionally, the retrieval may include at least the first associated text record and at least the second associated text record associated with the retrieved first associated text record.

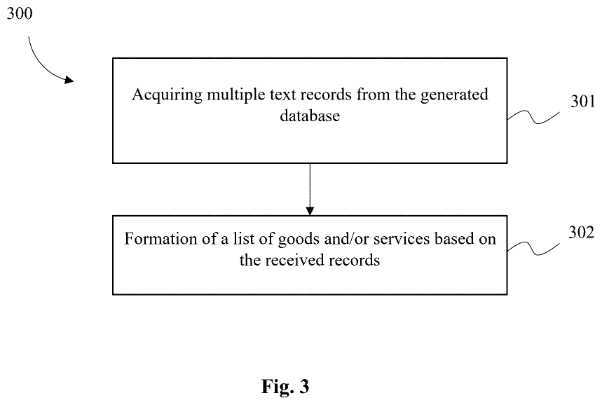

FIG. 3 presents a method (300) for forming a list of goods and services using the created database of associated records. As part of this method, following the implementation of method (200), the identification (301) of a set of text records retrieved from the database takes place, after which a list of goods and/or services (302) is formed. In this list, text records are listed using a delimiter, such as a semicolon (“;”) followed by a space, which is required because, typically, in the preparation of a trademark application, the list of goods and services must be formatted in this way. However, a specialist in this technical field will understand that any suitable delimiter may be used, provided it meets the requirements of the trademark application or enables the electronic trademark application system to process the electronic file containing the list of goods or services.

The set of extracted text records may include at least one of or any combination of:
The first associated text record linked to the first unique subheading;
The first unique subheading;
The second unique subheading;
The first associated text record linked to the second unique subheading;
The first associated text record linked to the first unique subheading,
The first unique subheading,
The second unique subheading,
The first associated text record linked to the second unique subheading,
The second associated text record linked to the first associated text record.

The generated list of products and/or services is then displayed on the user's computing device, server device, or in a web interface when using a web browser to access the listing. Additionally, the generated list may be automatically saved in a structured XML file.

The implementation of the solution, including creating the database, extracting data from it, and related processes, can be carried out using a computing device such as a personal computer, server, distributed server system, or in a client-server format.

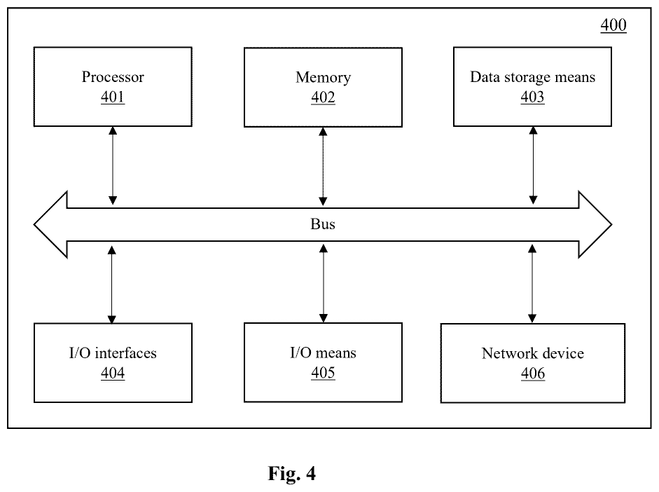

FIG. 4 illustrates a general example of a computing device (400), such as a computing unit (computational module), computer, server, laptop, smartphone, System-on-a-Chip (SoC), etc., which can be used for complete or partial implementation of the claimed solution, particularly for implementing methods (100, 200, 300). Generally, the device (400) includes components such as: one or more processors (401), at least one random access memory (RAM) (402), a data storage means (403), input/output interfaces (404), including relay outputs for connection to conveyor belt motion control controllers, I/O means (405), and networking means (406).

The processor (401) of the device performs the main computational operations required for the device (400) or one or more of its components to function. The processor (401) executes necessary machine-readable instructions contained in the RAM (402).

The memory (402) is generally implemented as RAM and contains the necessary program logic to provide the required functionality. The data storage means (403) may be implemented as HDD, SSD, RAID arrays, network storage, flash memory, or optical storage (CD, DVD, MD, Blu-ray discs), etc. The storage means (403) enables long-term storage of various types of information, such as request processing history (logs), user identifiers, camera data, images, etc.

Interfaces (404) are standard means for connecting and working with computing devices. These interfaces (404) may include, for example, relay connections, USB, RS232/422/485, RJ45, LPT, UART, COM, HDMI, PS/2, Lightning, FireWire, etc., supporting protocols such as Modbus and Profibus networks. The choice of interfaces (404) depends on the specific implementation of the device (400), which may represent a computing unit (computational module) based on a CPU (one or more processors), microcontroller, personal computer, mainframe, server cluster, thin client, smartphone, laptop, etc., as well as any external connected devices.

The I/O means (405) may include a keyboard, joystick, display (touchscreen), projector, touchpad, mouse, trackball, light pen, speakers, microphone, etc.

Networking means (406) are selected from devices providing network reception and transmission of data, such as an Ethernet card, WLAN/Wi-Fi module, Bluetooth module, BLE module, NFC module, IrDa, RFID module, GSM modem, etc. The means (406) enable data exchange through wired or wireless transmission channels, such as WAN, PAN, LAN, Intranet, Internet, WLAN, WMAN, GSM, quantum data channels, satellite communication, etc. The components of the device (400) are generally interconnected through a common data bus.

The materials presented in this application describe a preferred embodiment of the claimed technical solution, which should not be considered as limiting other specific implementations that fall within the scope of the requested legal protection and are obvious to experts in the relevant technical field.

1. A method for generating a list of text entries executed by the processor of a computer device, containing the following steps:
forming request to a database of the text records of a hierarchical classifier with several levels of nesting, and the database contains at least a set of the associated text records, wherein each of the associated text records associated with at least one first sign of connectivity, and each first sign of connectivity corresponds to one of the subheadings, and each unique text record is associated with a unique title, wherein each unique title contains a list consisting of at least plurality of the unique subheadings;
and the unique text records are associated in the database with one of the mentioned unique subheadings to obtain a set of associated text records;
extracting multiple associated text records from the database;
forming a list from the extracted text records, wherein the text records are written in the list using a delimiter.

2. The method according to claim 1, wherein the set of extracted text records includes at least one of or any combination of:
the first associated text entry associated with the first unique subtitle,
the first unique subtitle,
the second unique subtitle,
the first associated text entry associated with the second unique subtitle.

3. The method according to claim 1, wherein the set of extracted text records includes at least one of or any combination of:
the first associated text entry associated with the first unique subtitle,
the first unique subtitle,
the second unique subtitle,
the first associated text entry associated with the second unique subtitle,
the second associated text record associated with the extracted first associated text record.

4. The method according to claim 1, wherein the delimiter is a semicolon followed by a space.

5. The method according to claim 1, wherein the generated list is written to an XML file with a structure.
